(19) United States
(12) Patent Application Publication
(10) Pub. No.: US 2025/0069118 A1
(43) Pub. Date: Feb. 27, 2025

(54) Monetized Voice System and Method for Interactive Business Promotions Based on Artificial Intelligence

(71) Applicant: Stephen M. Byrd, Upper Marlboro, MD (US)

(72) Inventor: Stephen M. Byrd, Upper Marlboro, MD (US)

(21) Appl. No.: 18/931,125

(22) Filed: Oct. 30, 2024

Related U.S. Application Data
(63) Continuation-in-part of application No. 16/823,370, filed on Mar. 19, 2020, now abandoned.
(63) Continuation-in-part of application No. 17/408,858, filed on Aug. 23, 2021.

(51) Int. Cl. G06Q 30/0251; G10L 15/22

(52) U.S. Cl. CPC G06Q 30/0256; G06Q 30/0261; G10L 15/22; G10L 2015/221

(57) ABSTRACT

Embodiments of the present disclosure may include a system including a data storage populated with a plurality of merchant offers' data records. Embodiments may also include an artificial intelligence-based digital assistant module connected to the data storage over a network interface configured for two-way communication between the artificial intelligence-based digital assistant module and a plurality of computing devices. In some embodiments, the artificial intelligence-based digital assistant module may include an interactive graphical user interface configured to receive text input from a user. Embodiments may also include at least a first microphone configured to receive an audio input from the user. Embodiments may also include a geolocation module configured to generate geolocation data of the user. Embodiments may also include a keyword recognition module configured to process text-based commands from the user and transcode the text-based commands into voice data.

### CROSS REFERENCE TO RELATED APPLICATIONS

The present application is a Continuation-In-Part application of U.S. patent application Ser. No. 16/823,370 filed on 19 Mar. 2020, and patent application Ser. No. 17/408,858 filed on 23 Aug. 2021, which are herein incorporated in their entirety.

### FIELD OF THE DISCLOSURE

The present invention relates to Artificial Intelligence based informative digital assistant system, more particularly, voice-based digital assistant system for displaying live business deals, offers or promotions to the customers.

### BACKGROUND OF THE RELATED ART

No matter what kind of business you are, it's the rise of digital marketing. These online strategies are the ways in which companies can grow and expand. Virtual Marketing Assistants are a cost-effective, convenient way to leverage the expertise of an experienced marketing professional. For businesses, digital assistants provide a single, convenient point of contact for contractors and customers.

Digital assistants are most commonly used in customer contact centers to manage incoming communication. Digital assistants are complex and are backed with Artificial Intelligence. Especially, the use of Artificial Intelligence and Machine Learning helps customers to check live offers or business deals within a given geographical area hence customizing the end user experience.

### DESCRIPTION OF RELATED ARTS

US granted patent, U.S. Ser. No. 10/043,516B2 discloses an automated voice-based system for intelligent assistant. It is an information processing system that interprets natural language input in spoken and/or textual form to infer user intent, and performs actions based on the inferred user intent. In another prior art, bearing patent number, U.S. Ser. No. 10/909,980B2, it discloses methods, systems, and computer-readable mediums having instructions for implementing machine-learning digital assistants for advanced analytics, procurement, and operations tasks.

‘Bharath et al.’ in a US granted patent U.S. Pat. No. 9,047,631B2, discloses a method and system for providing location based customer assistance. This patent, more particularly, teaches about the method for providing a distributed mobile call center for a service establishment. 100071 In yet another patent application, US20130311286A1, John et al., claims a system and method for facilitating determination of marketing information for online consumers based on a location characteristic of the online consumer. Further, Westley et al. in the granted patent U.S. Ser. No. 10/672,066B2, teaches about digital assistant that interacts with the owner's mobile device.

In yet another patent application, bearing application number US20210134263A1, Victor et al. discloses a platform and system for the transcription of electronic online content from mostly visual/text format to an aural format, adapted for being read by an intelligent speaker system. It specifically discloses an automated engine with artificial intelligence and/or machine learning for the transformation of written websites into audioenabled content for use in association with new technology intelligent speakers, for implementing data mining, processing, and summarizing tools.

Another granted patent to Apple Inc., U.S. Pat. No. 9,548,050B2 filed by Thomas et al. teaches about an intelligent automated assistant system that engages with the user in an integrated, conversational manner using natural language dialog, and invokes external services when appropriate to obtain information or perform various actions.

None of the above discussed prior arts teaches about informative voice based, AI enabled digital assistants specifically meant for displaying location based live business deals, promotions or offers as per customer interests and preferred geographical locations.

### SUMMARY OF THE INVENTION

Embodiments of the present disclosure may include a system including a data storage populated with a plurality of merchant offers' data records. Embodiments may also include an artificial intelligence-based digital assistant module connected to the data storage over a network interface configured for two-way communication between the artificial intelligence-based digital assistant module and a plurality of computing devices.

In some embodiments, the artificial intelligence-based digital assistant module may include an interactive graphical user interface configured to receive text input from a user. Embodiments may also include at least a first microphone configured to receive an audio input from the user. Embodiments may also include a geolocation module configured to generate geolocation data of the user.

Embodiments may also include a keyword recognition module configured to process text-based commands from the user and transcode the text-based commands into voice data. Embodiments may also include a speech processing module configured to process audio input from the user. In some embodiments, the speech processing module may be further configured to parse the audio input to derive at least one keyword from the audio input.

Embodiments may also include distinguish purchase-related inputs from standard speech through trained recognition patterns. Embodiments may also include generate contextual purchase prompts based on the distinguished purchase-related inputs. Embodiments may also include an adaptive feedback module configured to interject during user inputs based on learned purchase flows.

Embodiments may also include provide real-time guidance to users for proper voice input format based on historical successful purchase patterns. Embodiments may also include dynamically adjust guidance based on user response patterns. Embodiments may also include a hierarchical search module configured to implement a two-step search process that first prioritizes brand-specific queries before performing broader keyword searches.

Embodiments may also include when a brand name may be recognized, initially limit search results to that brand's offerings before expanding to related products. Embodiments may also include when no brand name may be detected, proceed with keyword-based search using identified relevant terms. Embodiments may also include filter out non-value-adding words from search queries to improve search precision.

Embodiments may also include a purchase prompt and confirmation module configured to enable users to complete purchases using stored payment methods and provide delivery or pickup options. Embodiments may also include a user ratings module configured to allow users to hear ratings for products they may be interested in. Embodiments may also include a product availability notifications module configured to notify users when products may be available and facilitate automatic purchases.

In some embodiments, the digital assistant module may be configured to receive input data including voice or text. In some embodiments, the digital assistant module may be configured to parse the input data for at least one keyword. In some embodiments, the digital assistant module may be coupled to the data storage and configured to fetch at least one merchant offers' data record based on the at least one keyword. In some embodiments, the digital assistant module may be configured to transcode the at least one merchant offers' data record into voice data. In some embodiments, the digital assistant module may be configured to transmit the voice data over the network interface to the plurality of computing devices.

In some embodiments, the speech processing module may be further configured to identify and parse specific elements from purchase-related inputs including product specifications, payment method preferences, and delivery options. Embodiments may also include maintain context awareness across multiple user utterances within a single shopping session. Embodiments may also include adapt speech recognition patterns based on successful purchase completions.

In some embodiments, the adaptive feedback module may be further configured to track common error patterns in user voice inputs. Embodiments may also include generate personalized correction suggestions based on user's historical interaction patterns. Embodiments may also include store successful voice input patterns for future reference and guidance. Embodiments may also include provide progressive guidance by starting with minimal intervention and increasing assistance based on user response.

In some embodiments, the hierarchical search module's two-step search process may include a first search phase that identifies and extracts brand names from user input. Embodiments may also include queries brand-specific product databases. Embodiments may also include ranks results based on brand relevance scores.

Embodiments may also include a second search phase that activates when no brand may be identified or brand-specific results may be insufficient. Embodiments may also include performs keyword-based search across all product categories. Embodiments may also include applies relevance filtering based on user context and history.

In some embodiments, the filter algorithm of the hierarchical search module may be configured to maintain a dynamic database of non-value-adding words. Embodiments may also include analyze word frequency and correlation with successful searches. Embodiments may also include remove common filler words while preserving context-specific terms. Embodiments may also include adapt filtering rules based on search success rates.

In some embodiments, the speech processing module implements a learning algorithm that tracks successful purchase-related voice interactions. Embodiments may also include identifies patterns in voice inputs that lead to completed purchases. Embodiments may also include adjusts recognition parameters based on user-specific speech patterns. Embodiments may also include maintains separate recognition models for purchase-related and non-purchase speech.

In some embodiments, the adaptive feedback module implements a purchase flow training model that analyzes historical purchase completion data. Embodiments may also include identifies common points of user hesitation or confusion. Embodiments may also include generates context-appropriate intervention triggers. Embodiments may also include customizes guidance based on product category and user expertise level.

Embodiments may also include receiving and processing user input may include receiving user input through multiple channels including voice input through at least one microphone. Embodiments may also include text input through a typing interface. Embodiments may also include location data through a global positioning system.

Embodiments may also include processing the multi-channel input by analyzing voice commands through the speech processing module. Embodiments may also include processing text-based commands through the keyword recognition module. Embodiments may also include integrating GPS data with search parameters. Embodiments may also include maintaining context across input channels by synchronizing user intent across voice and text inputs.

Embodiments may also include preserving search context across input methods. Embodiments may also include combining location context with user queries. Embodiments may also include adapting input processing based on user's preferred input methods. Embodiments may also include historical success rates of different input channels. Embodiments may also include current interaction context.

Embodiments of the present disclosure may also include a method including the steps of receiving by an artificial intelligence-based digital assistant module connected to a data storage over a network interface at least one merchant offers' data record via a network interface. Embodiments may also include storing by the artificial intelligence-based digital assistant module the at least one merchant offers' data record in the data storage.

Embodiments may also include receiving by the artificial intelligence-based digital assistant module inbound voice data and user geolocation data from a user communication device via the network interface. Embodiments may also include processing the inbound voice data by distinguishing purchase-related inputs from standard speech using trained recognition patterns.

Embodiments may also include identifying specific elements including product specifications, payment preferences, and delivery options. Embodiments may also include generating contextual purchase prompts based on the distinguished purchase-related inputs. Embodiments may also include implementing an adaptive feedback process including monitoring user input patterns in real-time.

Embodiments may also include interjecting during user inputs based on learned purchase flows. Embodiments may also include providing dynamic guidance for proper voice input format based on historical successful purchase patterns. Embodiments may also include performing a hierarchical search process including executing a first search phase that prioritizes brand-specific queries by identifying and extracting brand names from the inbound voice data.

Embodiments may also include querying brand-specific product databases. Embodiments may also include ranking results based on brand relevance scores. Embodiments may also include executing a second search phase when no brand may be identified or brand-specific results may be insufficient by filtering out non-value-adding words while preserving context-specific terms.

Embodiments may also include performing keyword-based search across all product categories. Embodiments may also include applying relevance filtering based on user context and history. Embodiments may also include deriving by the artificial intelligence-based digital assistant module at least one keyword from the inbound voice data.

Embodiments may also include fetching by the artificial intelligence-based digital assistant module the at least one merchant offers' data record from the data storage based on the at least one keyword. Embodiments may also include inbound location data. Embodiments may also include results of the hierarchical search process.

Embodiments may also include user's historical purchase patterns. Embodiments may also include transcoding by the artificial intelligence-based digital assistant module the at least one merchant offers' data record to outbound voice data. Embodiments may also include transmitting by the artificial intelligence-based digital assistant module the outbound voice data via network interface to the user communication device.

Embodiments may also include continuously improving search accuracy by tracking successful purchase completions. Embodiments may also include analyzing patterns in voice inputs that lead to successful purchases. Embodiments may also include updating speech recognition models based on aggregate user data. Embodiments may also include refining search algorithms based on purchase completion rates.

In some embodiments, the data storage may include a database containing latest offers, business promotions, and live deals within a given geographical area of a user. In some embodiments, the trained recognition patterns may be continuously updated based on successful purchase completions. In some embodiments, the learned purchase flows may be derived from historical successful transactions. In some embodiments, the hierarchical search process adapts its ranking algorithms based on user-specific purchase patterns.

Embodiments may also include processing the inbound voice data may include receiving voice keywords from the user through a trained speech recognition model. Embodiments may also include determining the geographical location of the user through real-time GPS data. Embodiments may also include analyzing the voice keywords in conjunction with the geographical location to identify relevant local offers and promotions.

Embodiments may also include filter results based on proximity to user location. Embodiments may also include rank results based on both relevance and distance. Embodiments may also include present geographically-targeted voice results around the vicinity of the user. Embodiments may also include continuously updating the local offer database based on user interaction patterns with local offers. Embodiments may also include successful purchase completions within specific geographical areas. Embodiments may also include temporal relevance of offers and promotions.

### BRIEF DESCRIPTION OF THE DRAWINGS

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention.

FIG. 1 is a block diagram illustrating a system, according to some embodiments of the present disclosure.

FIG. 2 is a block diagram further illustrating the system from FIG. 1, according to some embodiments of the present disclosure.

FIG. 3 is a block diagram further illustrating the system from FIG. 1, according to some embodiments of the present disclosure.

FIG. 4 is a block diagram further illustrating the system from FIG. 1, according to some embodiments of the present disclosure.

FIG. 5A is a flowchart illustrating a method, according to some embodiments of the present disclosure.

FIG. 5B is a flowchart extending from FIG. 5A and further illustrating the method, according to some embodiments of the present disclosure.

FIG. 5C is a flowchart extending from FIG. 5B and further illustrating the method from FIG. 5A, according to some embodiments of the present disclosure.

FIG. 5D is a flowchart extending from FIG. 5C and further illustrating the method from FIG. 5A, according to some embodiments of the present disclosure.

FIG. 6 is a flowchart further illustrating the method from FIG. 5A, according to some embodiments of the present disclosure.

### DETAILED DESCRIPTION OF THE INVENTION

Unless otherwise defined, all technical terms used herein related to voice recognition, artificial intelligence, machine learning, search algorithms, and e-commerce systems have the same meaning as commonly understood by one of ordinary skill in the relevant arts of speech processing, digital assistants, and electronic commerce. It will be further understood that terms such as “speech recognition,” “natural language processing,” “machine learning,” “artificial intelligence,” and other technical terms commonly used in the fields of voice commerce and digital assistants should be interpreted as having meanings consistent with their usage in the context of this specification and the current state of voice shopping technology. These terms should not be interpreted in an idealized or overly formal sense unless expressly defined herein. For brevity and clarity, well-known functions or constructions related to voice processing, search algorithms, or e-commerce systems may not be described in detail.

The terminology used herein describes particular embodiments of the voice-based shopping system and is not intended to be limiting. As used herein, singular forms such as “a speech recognition module,” “an adaptive feedback module,” and “the hierarchical search process” are intended to include plural forms as well, unless the context clearly indicates otherwise. Similarly, references to “voice input” or “search process” should be understood to include multiple instances or iterations of such elements, where applicable.

With reference to the use of the words “comprise” or “comprises” or “comprising” in describing the components, processes, or functionalities of the voice-based shopping system, and in the following claims, unless the context requires otherwise, these words are used on the basis and clear understanding that they are to be interpreted inclusively rather than exclusively. For example, when referring to “comprising a speech recognition module,” the term should be understood to mean including but not limited to the described speech recognition capabilities, and may include additional related functionalities or components not explicitly described. Each instance of these words is to be interpreted inclusively in construing the description and claims, particularly in relation to the modular and adaptable nature of the voice shopping system described herein.

Furthermore, terms such as “connected,” “coupled,” or “communication with” as used in describing the interaction between various modules of the system (such as between the speech processing module and the adaptive feedback module) should be interpreted to include both direct connections and indirect connections through one or more intermediary components, unless explicitly stated otherwise. References to “processing,” “analyzing,” or “adapting” should be understood to encompass both real-time operations and delayed or batch processing, unless specifically limited to one or the other in the context.

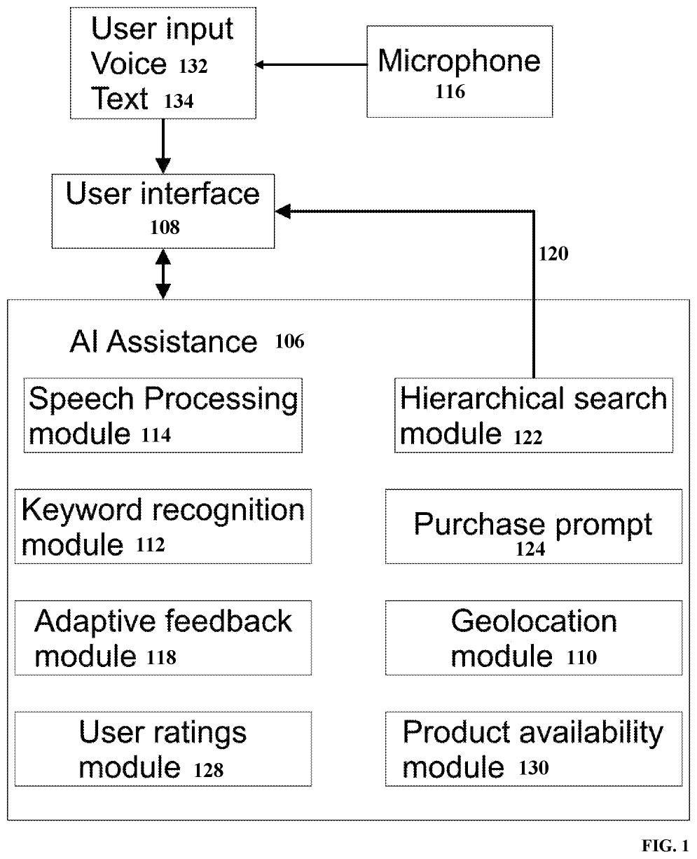

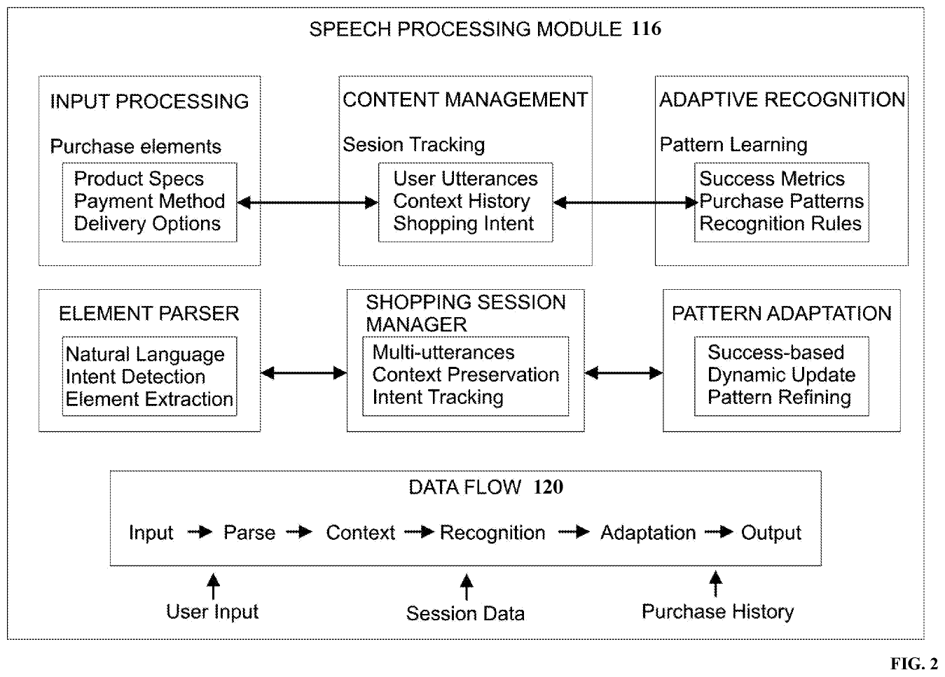

In some aspects thereof, FIG. 1 is a block diagram that describes a system 102, according to some embodiments of the present disclosure. In some embodiments, the system 102 may include a data storage 104 populated with a plurality of merchant offers' data records, an artificial intelligence-based digital assistant module 106 connected to the data storage 104 over a network interface configured for two-way communication between the artificial intelligence-based digital assistant module 106 and a plurality of computing devices, an interactive graphical user interface 108 configured to receive text input from a user, a geolocation module 110 configured to generate geolocation data of the user, a keyword recognition module 112 configured to process text-based commands from the user and transcode the text-based commands into voice data, a speech processing module 114 configured to: process audio input 116 from the user, an adaptive feedback module 118 configured to: interject 120 during user inputs based on learned purchase flows, a hierarchical search module 122 configured to: a purchase prompt 124, confirmation module 126 configured to enable users to complete purchases using stored payment methods and provide delivery or pickup options, a user ratings module 128 configured to allow users to hear ratings for products they may be interested in, a product availability notifications module 130 may configured to notify users when products may be available and facilitate automatic purchases, by voice 132, and/or text 134.

In some embodiments, at least a first microphone configured to receive an audio input from the user. The speech processing module 114 may be further configured to parse the audio input to derive at least one keyword from the audio input. Distinguish purchase-related inputs from standard speech through trained recognition patterns. Generate contextual purchase prompts based on the distinguished purchase-related inputs.

In some embodiments, provide real-time guidance to users for proper voice input format based on historical successful purchase patterns. Dynamically adjust guidance based on user response patterns. Implement a two-step search process that first prioritizes brand-specific queries before performing broader keyword searches. When a brand name may be recognized, initially limit search results to that brand's offerings before expanding to related products.

In some embodiments, when no brand name may be detected, proceed with keyword-based search using identified relevant terms. Filter out non-value-adding words from search queries to improve search precision. The digital assistant module 106 may be configured to receive input data. The digital assistant module 106 may be configured to parse the input data for at least one keyword. The digital assistant module 106 may be coupled to the data storage 104 and configured to fetch at least one merchant may offer' data record based on the at least one keyword. The digital assistant module 106 may be configured to transcode the at least one merchant may offer' data record into voice data. The digital assistant module 106 may be configured to transmit the voice data over the network interface to the plurality of computing devices.

In some embodiments, the adaptive feedback module 118 may be further configured to: Track common error patterns in user voice may input. Generate personalized correction suggestions based on user's historical interaction patterns. Store successful voice input patterns for future reference and guidance. Provide progressive guidance by starting with minimal intervention and increasing assistance based on user response.

In some embodiments, the filter algorithm of the hierarchical search module 122 may be configured to: Maintain a dynamic database of non-value-adding words. Analyze word frequency and correlation with successful searches. Remove common filler words while preserving context-specific terms. Adapt filtering rules based on search success rates. In some embodiments, the speech processing module 114 may implement a learning algorithm that: Tracks successful purchase-related voice interactions. Identifies patterns in voice may input that lead to completed purchases. Maintains separate recognition models for purchase-related and non-purchase speech. In some embodiments, the adaptive feedback module implements a purchase flow training model that: Analyzes historical purchase completion data. Identifies common points of user hesitation or confusion. Generates context-appropriate intervention may trigger. Customizes guidance based on product category and user expertise level.

On the other hand, the FIG. 2 is a block diagram that further describes the system 102 from FIG. 1, according to some embodiments of the present disclosure. In some embodiments, the speech processing module 114 may be further configured to: Identify and parse specific elements from purchase-related inputs. Maintain context awareness across multiple user utterances within a single shopping session. Adapt speech recognition patterns based on successful purchase completions.

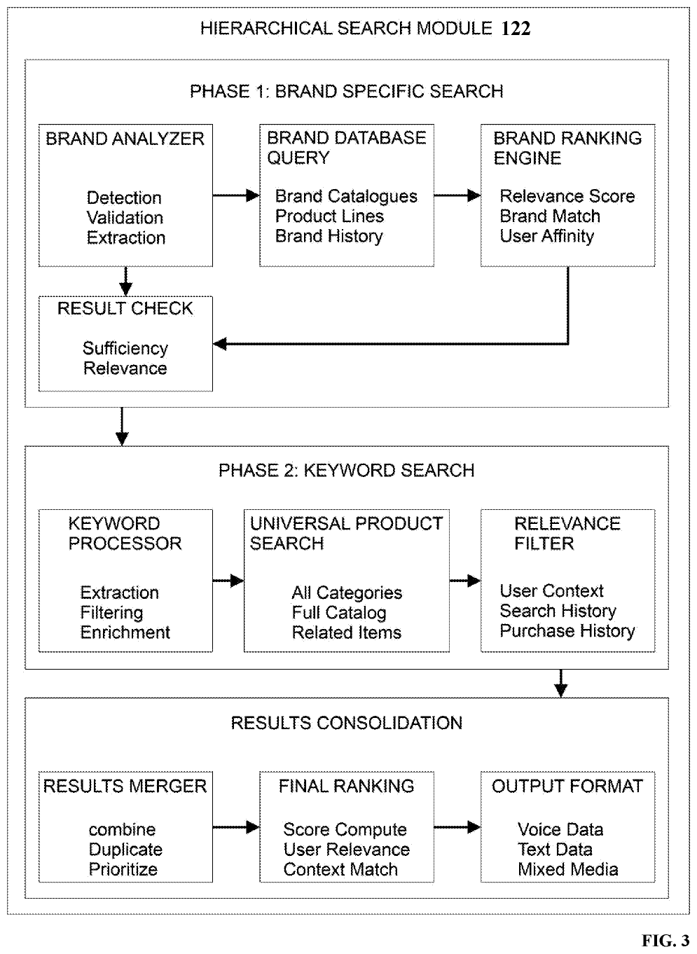

Further, the FIG. 3 is a block diagram that further describes the system 102 from FIG. 1, according to some embodiments of the present disclosure. In some embodiments, the hierarchical search module's two-step search process. Queries brand-specific product databases. Ranks results based on brand relevance scores. Activates when no brand may be identified or brand-specific results may be insufficient. Performs keyword-based search across all product categories. Applies relevance filtering based on user context and history.

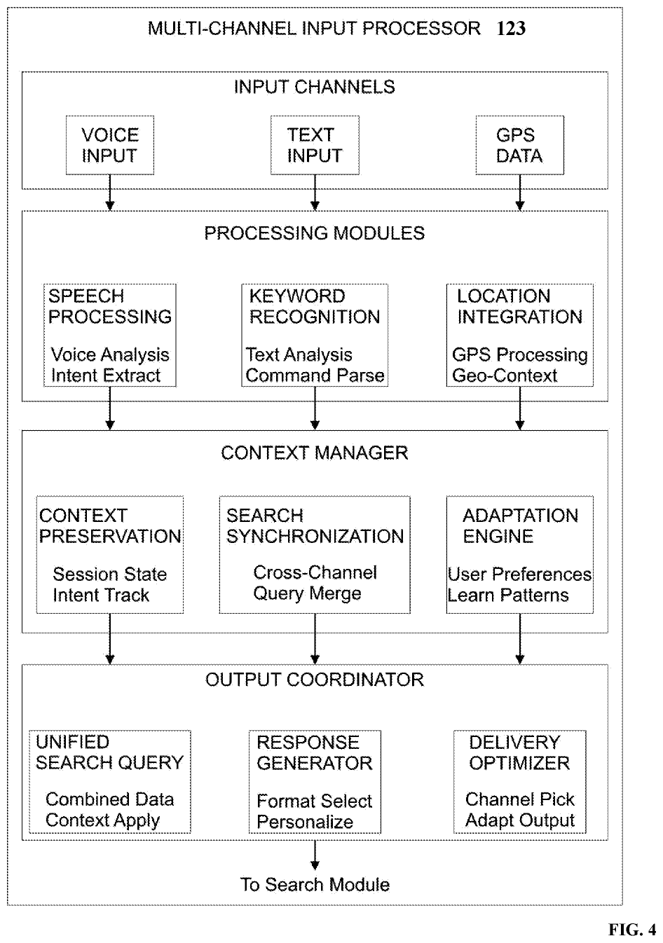

Even further, the FIG. 4 is a block diagram that further describes the system 102 from FIG. 1, according to some embodiments of the present disclosure. In some embodiments, receiving and processing user input. Receiving user input through multiple channels. Processing the multi-channel input by: Analyzing voice commands through the speech processing module 114. Processing text-based commands through the keyword recognition module 112. Integrating GPS data with search parameters. Maintaining context across input channels by: Preserving search context across input methods. Combining location context with user queries. Adapting input processing based on: User's preferred input methods.

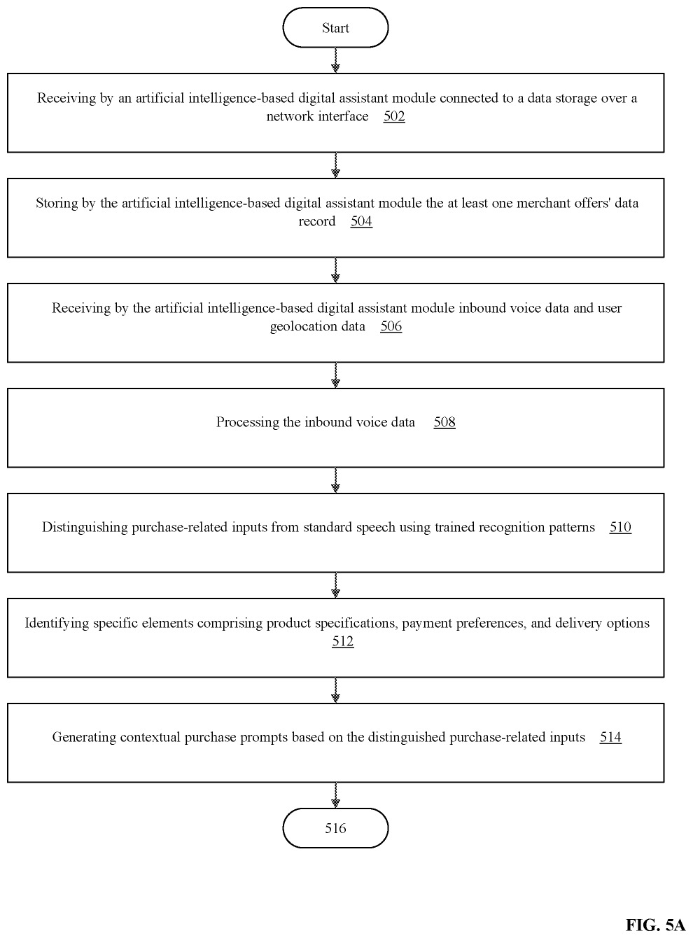

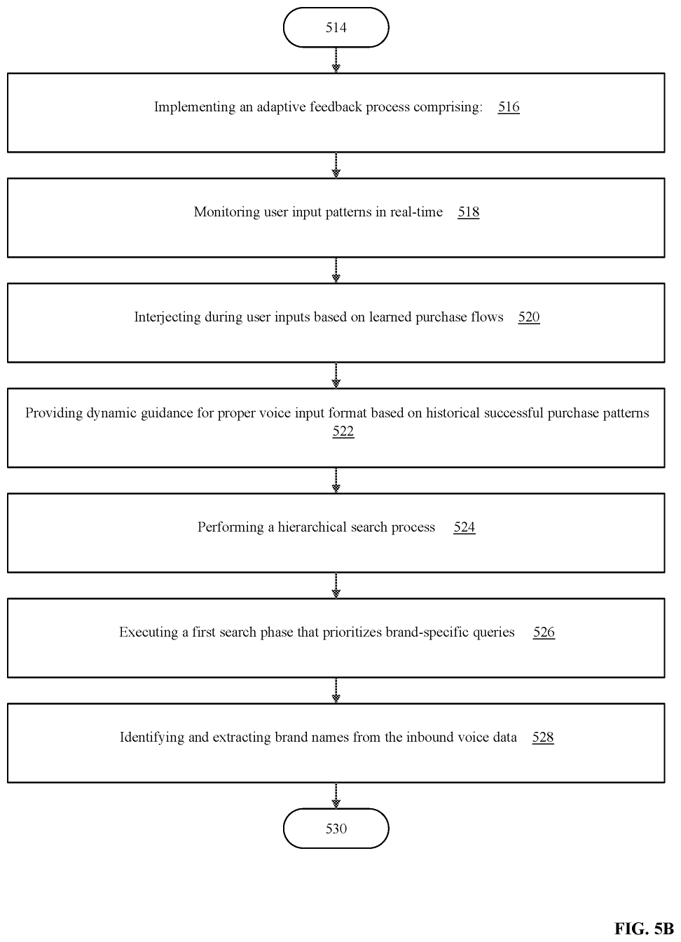

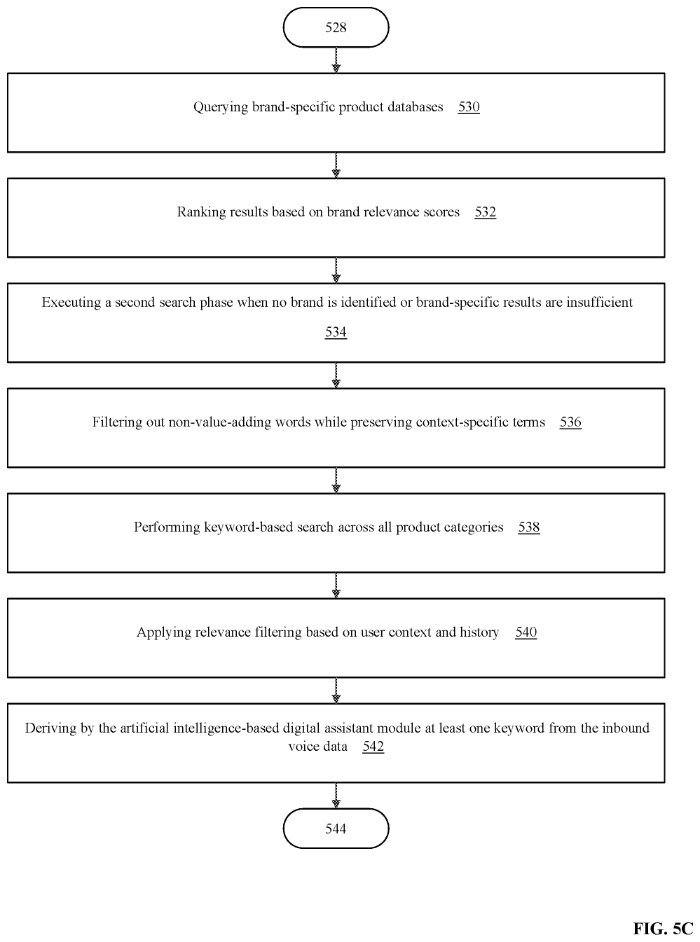

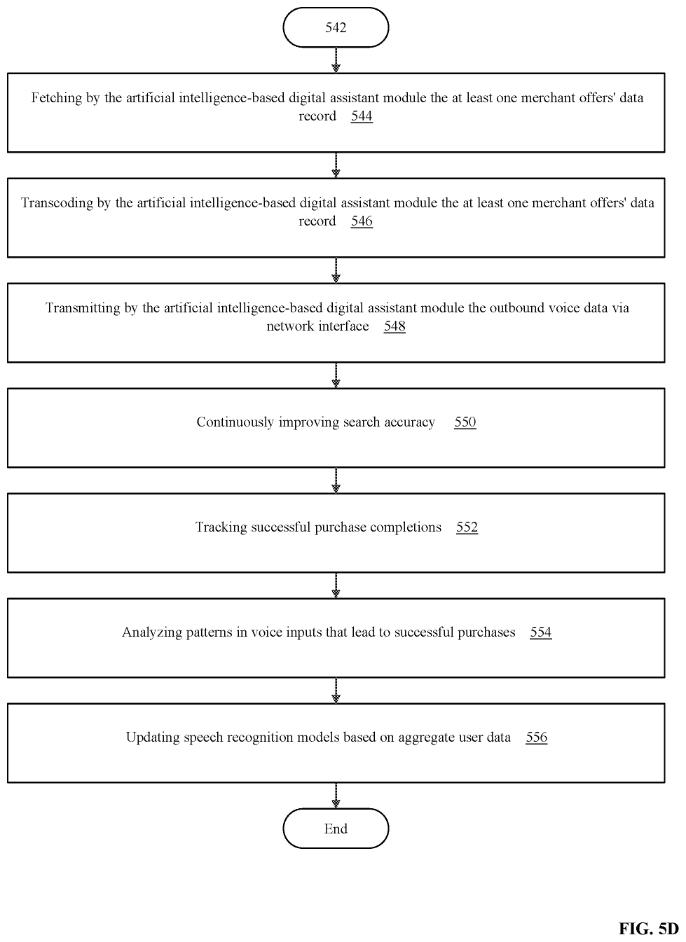

The further illustrations of FIGS. 5A, 5B, 5C and 5D are flowcharts that describe a method, according to some embodiments of the present disclosure. In some embodiments, at 502, the method may include receiving by an artificial intelligence-based digital assistant module connected to a data storage over a network interface at least one merchant offers' data record via a network interface. At 504, the method may include storing by the artificial intelligence-based digital assistant module the at least one merchant offers' data record in the data storage.

In some embodiments, at 506, the method may include receiving by the artificial intelligence-based digital assistant module inbound voice data and user geolocation data from a user communication device via the network interface. At 508, the method may include processing the inbound voice data by: At 510, the method may include distinguishing purchase-related inputs from standard speech using trained recognition patterns.

In some embodiments, at 512, the method may include identifying specific elements comprising product specifications, payment preferences, and delivery options. At 514, the method may include generating contextual purchase prompts based on the distinguished purchase-related inputs. At 516, the method may include implementing an adaptive feedback process comprising: At 518, the method may include monitoring user input patterns in real-time.

In some embodiments, at 520, the method may include interjecting during user inputs based on learned purchase flows. At 522, the method may include providing dynamic guidance for proper voice input format based on historical successful purchase patterns. At 524, the method may include performing a hierarchical search process comprising: At 526, the method may include executing a first search phase that prioritizes brand-specific queries by:

In some embodiments, at 528, the method may include identifying and extracting brand names from the inbound voice data. At 530, the method may include querying brand-specific product databases. At 532, the method may include ranking results based on brand relevance scores. At 534, the method may include executing a second search phase when no brand may be identified or brand-specific results may be insufficient by: At 536, the method may include filtering out non-value-adding words while preserving context-specific terms.

In some embodiments, at 538, the method may include performing keyword-based search across all product categories. At 540, the method may include applying relevance filtering based on user context and history. At 542, the method may include deriving by the artificial intelligence-based digital assistant module at least one keyword from the inbound voice data. At 544, the method may include fetching by the artificial intelligence-based digital assistant module the at least one merchant offers' data record from the data storage based on:

In some embodiments, at 546, the method may include transcoding by the artificial intelligence-based digital assistant module the at least one merchant offers' data record to outbound voice data. At 548, the method may include transmitting by the artificial intelligence-based digital assistant module the outbound voice data via network interface to the user communication device. At 550, the method may include continuously improving search accuracy by: At 552, the method may include tracking successful purchase completions. At 554, the method may include analyzing patterns in voice inputs that lead to successful purchases. At 556, the method may include updating speech recognition models based on aggregate user data.

In some embodiments, the steps of, the method may include 502 to 556. The at least one keyword. Inbound location data. Results of the hierarchical search process. User's historical purchase patterns. Refining search algorithms based on purchase completion rates. The data storage may comprise a database containing latest offers, business promotions, and live deals within a given geographical area of a user. The trained recognition patterns may be continuously updated based on successful purchase completions. The learned purchase flows may be derived from historical successful transactions. The hierarchical search process may adapt its ranking algorithms based on user-specific purchase patterns.

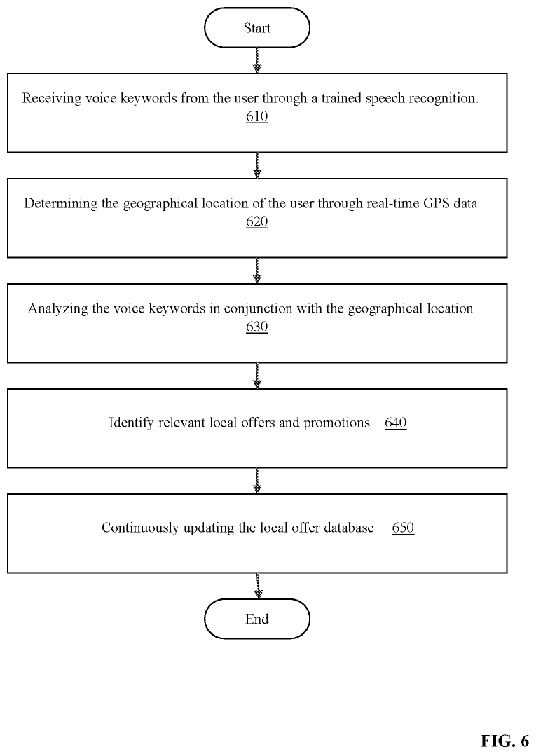

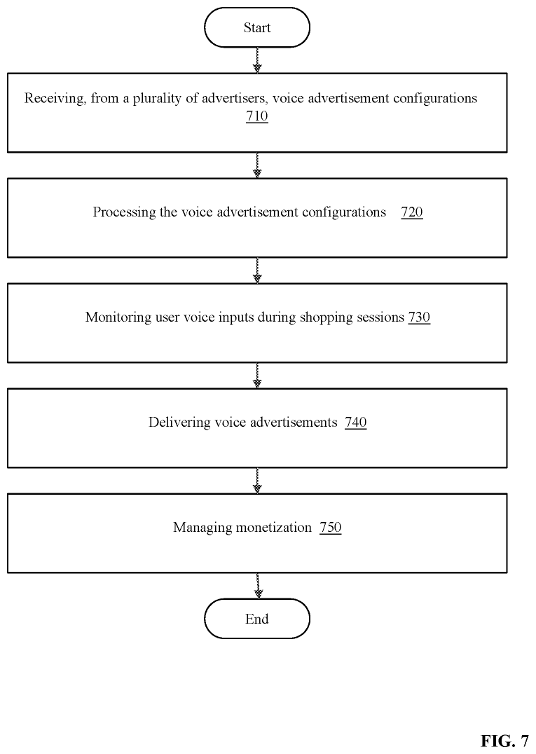

The further FIG. 6 is a flowchart that further describes the method from FIG. 5A, according to some embodiments of the present disclosure. In some embodiments, processing the inbound voice data further comprises, the method may include 610 to 650. Filter results based on proximity to user location. Rank results based on both relevance and distance. Present geographically-targeted voice results around the vicinity of the user. User interaction patterns with local offers. Successful purchase completions within specific geographical areas. Temporal relevance of offers and promotions.

In some aspects, the FIG. 7 demonstrates a monetization structure that preferably combines both advertiser-based and subscription-based revenue models. In accordance with step 710 for receiving voice advertisement configurations, the system implements a pay-per-voice (PPV) model where businesses can create and manage voice-optimized advertisements. Advertisers input their promotional content along with specific configuration parameters, including text-format advertisements, trigger keywords for voice activation, budget allocations, target audience parameters, and desired number of voice impressions. Following this, in step 720 for processing voice advertisement configurations, the system processes the submitted advertising content through several steps, including converting submitted text advertisements into voice format, mapping specified trigger keywords to the speech recognition module, storing processed voice advertisements in the data storage, and preparing advertisements for dynamic delivery based on advertiser parameters.

As outlined in step 730 for monitoring user voice inputs, the speech processing module actively monitors user interactions by identifying advertising keywords in user speech during shopping sessions, analyzing user context and engagement patterns, and utilizing the adaptive feedback module to learn optimal advertisement placement patterns while maintaining natural conversation flow during monitoring. In accordance with step 740 for delivering voice advertisements, advertisement delivery is managed through prioritizing delivery based on advertiser parameters, incorporating advertiser priority in search results through the hierarchical search module, balancing paid and organic results to maintain user experience, and tracking impression counts and budget utilization.

Finally, as detailed in step 750 for managing monetization, the system implements a dual revenue structure. The advertiser-based model component focuses on tracking voice impression credits, managing budget utilization, and monitoring advertisement performance. Simultaneously, the subscription-based model component offers tiered service levels ranging from basic (with ads) to premium (ad-free), providing enhanced features such as ad-free voice shopping, enhanced product recommendations, priority processing, and advanced customization options, while also managing enterprise-level accounts with sophisticated features.

In some aspects, the system implements a monetization structure that combines both advertiser-based and subscription-based revenue models. Through an advertisement management module, businesses can create and manage voice-optimized advertisements, selecting specific keywords that trigger their promotional content when voiced by users during shopping interactions. This pay-per-voice (PPV) model allows advertisers to purchase voice impression credits, set specific budgets for advertisement delivery, and define precise targeting parameters for their desired audience.

Further, the advertisement delivery process begins when advertisers input their content in text format, along with selected trigger keywords, desired number of voice impressions, and budget allocations. The system processes this content by converting text advertisements to voice format, mapping the keywords to the speech recognition module, and storing the voice advertisements in the data storage. As users interact with the system, their voice inputs are monitored for keyword matches, triggering relevant voice advertisements when appropriate while maintaining careful tracking of impression counts and budget utilization.

In parallel with the advertiser-based model, the system offers a subscription-based service where users can opt for a premium experience. This includes ad-free voice shopping, enhanced product recommendations, priority processing, and access to advanced features. The subscription model is structured in tiers, ranging from a basic level that includes advertisements to premium and enterprise levels offering increasingly sophisticated features and customization options.

The monetization features are integrated with the core system architecture. The speech processing module identifies advertising keywords in user speech and prioritizes advertisement delivery based on advertiser parameters while maintaining natural conversation flow. The adaptive feedback module learns optimal advertisement placement patterns and adjusts delivery based on user engagement metrics. Meanwhile, the hierarchical search module incorporates advertiser priority in search results while maintaining a careful balance between paid and organic results to optimize the overall user experience.

To ensure transparency and effectiveness, the system preferably implements advanced tracking capabilities that measure advertisement performance through voice impression delivery counts, user engagement metrics, and conversion tracking. Advertisers receive access to real-time performance dashboards, keyword effectiveness reports, and optimization recommendations. The billing and payment processing component manages both advertiser payments based on voice impression delivery and subscription payments through automated billing cycles and usage reporting.

This monetization approach enables multiple revenue streams while providing flexible advertising options for businesses and enhanced user experience options for shoppers. The system's ability to track and measure performance metrics ensures that both advertisers and subscribers receive measurable value from their investment, while the adaptive nature of the system continuously optimizes the balance between monetization and user experience. Through this dual approach of advertising and subscription revenue, the system maintains financial sustainability while providing value to all stakeholders in the voice shopping ecosystem.

What is claimed is:

1. A system comprising:
a data storage populated with a plurality of merchant offers' data records;
an artificial intelligence-based digital assistant module connected to the data storage over a network interface configured for two-way communication between the artificial intelligence-based digital assistant module and a plurality of computing devices wherein:
the artificial intelligence-based digital assistant module comprises:
an interactive graphical user interface configured to receive text input from a user;
at least a first microphone configured to receive an audio input from the user;
a geolocation module configured to generate geolocation data of the user;
a keyword recognition module configured to process text-based commands from the user and transcode the text-based commands into voice data;
a speech processing module configured to:
process audio input from the user wherein the speech processing module is further configured to parse the audio input to derive at least one keyword from the audio input;
distinguish purchase-related inputs from standard speech through trained recognition patterns;
generate contextual purchase prompts based on the distinguished purchase-related inputs;
an adaptive feedback module configured to:
interject during user inputs based on learned purchase flows;
provide real-time guidance to users for proper voice input format based on historical successful purchase patterns;
dynamically adjust guidance based on user response patterns;
a hierarchical search module configured to:
implement a two-step search process that first prioritizes brand-specific queries before performing broader keyword searches;
when a brand name is recognized, initially limit search results to that brand's offerings before expanding to related products;
when no brand name is detected, proceed with keyword-based search using identified relevant terms;
filter out non-value-adding words from search queries to improve search precision;
a purchase prompt and confirmation module configured to enable users to complete purchases using stored payment methods and provide delivery or pickup options;
a user ratings module configured to allow users to hear ratings for products they are interested in;
a product availability notifications module configured to notify users when products are available and facilitate automatic purchases;
wherein:
the digital assistant module is configured to receive input data comprising voice or text;
the digital assistant module is configured to parse the input data for at least one keyword;
the digital assistant module is coupled to the data storage and configured to fetch at least one merchant offers' data record based on the at least one keyword;
the digital assistant module is configured to transcode the at least one merchant offers' data record into voice data;
the digital assistant module is configured to transmit the voice data over the network interface to the plurality of computing devices.

2. The system of claim 1, wherein the speech processing module is further configured to:
identify and parse specific elements from purchase-related inputs comprising: product specifications, payment method preferences, and delivery options;
maintain context awareness across multiple user utterances within a single shopping session;
adapt speech recognition patterns based on successful purchase completions.

3. The system of claim 1, wherein the adaptive feedback module is further configured to:
track common error patterns in user voice inputs;
generate personalized correction suggestions based on user's historical interaction patterns;
store successful voice input patterns for future reference and guidance;
provide progressive guidance by starting with minimal intervention and increasing assistance based on user response.

4. The system of claim 1, wherein the hierarchical search module's two-step search process comprises:
a first search phase that:
identifies and extracts brand names from user input;
queries brand-specific product databases;
ranks results based on brand relevance scores;
a second search phase that:
activates when no brand is identified or brand-specific results are insufficient;
performs keyword-based search across all product categories;
applies relevance filtering based on user context and history.

5. The system of claim 1, wherein the filter algorithm of the hierarchical search module is configured to:
maintain a dynamic database of non-value-adding words;
analyze word frequency and correlation with successful searches;
remove common filler words while preserving context-specific terms;
adapt filtering rules based on search success rates.

6. The system of claim 1, wherein the speech processing module implements a learning algorithm that:
tracks successful purchase-related voice interactions;
identifies patterns in voice inputs that lead to completed purchases;
adjusts recognition parameters based on user-specific speech patterns;
maintains separate recognition models for purchase-related and non-purchase speech.

7. The system of claim 1, wherein the adaptive feedback module implements a purchase flow training model that:
analyzes historical purchase completion data;
identifies common points of user hesitation or confusion;
generates context-appropriate intervention triggers;
customizes guidance based on product category and user expertise level

8. A method comprising the steps of:
receiving by an artificial intelligence-based digital assistant module connected to a data storage over a network interface at least one merchant offers' data record via a network interface;
storing by the artificial intelligence-based digital assistant module the at least one merchant offers' data record in the data storage;
receiving by the artificial intelligence-based digital assistant module inbound voice data and user geolocation data from a user communication device via the network interface;
processing the inbound voice data by:
distinguishing purchase-related inputs from standard speech using trained recognition patterns;
identifying specific elements comprising product specifications, payment preferences, and delivery options;
generating contextual purchase prompts based on the distinguished purchase-related inputs;
implementing an adaptive feedback process comprising:
monitoring user input patterns in real-time;
interjecting during user inputs based on learned purchase flows;
providing dynamic guidance for proper voice input format based on historical successful purchase patterns;
performing a hierarchical search process comprising:
executing a first search phase that prioritizes brand-specific queries by:
identifying and extracting brand names from the inbound voice data;
querying brand-specific product databases;
ranking results based on brand relevance scores;
executing a second search phase when no brand is identified or brand-specific results are insufficient by:
filtering out non-value-adding words while preserving context-specific terms;
performing keyword-based search across all product categories;
applying relevance filtering based on user context and history;
deriving by the artificial intelligence-based digital assistant module at least one keyword from the inbound voice data;
fetching by the artificial intelligence-based digital assistant module the at least one merchant offers' data record from the data storage based on:
the at least one keyword;
inbound location data;
results of the hierarchical search process;
user's historical purchase patterns;
transcoding by the artificial intelligence-based digital assistant module the at least one merchant offers' data record to outbound voice data;
transmitting by the artificial intelligence-based digital assistant module the outbound voice data via network interface to the user communication device;
continuously improving search accuracy by:
tracking successful purchase completions;
analyzing patterns in voice inputs that lead to successful purchases;
updating speech recognition models based on aggregate user data;
refining search algorithms based on purchase completion rates;
wherein:
the data storage comprises a database containing latest offers, business promotions, and live deals within a given geographical area of a user;
the trained recognition patterns are continuously updated based on successful purchase completions;
the learned purchase flows are derived from historical successful transactions;
the hierarchical search process adapts its ranking algorithms based on user-specific purchase patterns.

9. The method according to claim 8 wherein processing the inbound voice data further comprises:
receiving voice keywords from the user through a trained speech recognition model;
determining the geographical location of the user through real-time GPS data;
analyzing the voice keywords in conjunction with the geographical location to:
identify relevant local offers and promotions;
filter results based on proximity to user location;
rank results based on both relevance and distance;
present geographically-targeted voice results around the vicinity of the user;
continuously updating the local offer database based on:
user interaction patterns with local offers;
successful purchase completions within specific geographical areas;
temporal relevance of offers and promotions.

10. The method according to claim 1 wherein receiving and processing user input comprises:
receiving user input through multiple channels comprising:
voice input through at least one microphone;
text input through a typing interface;
location data through a global positioning system;
processing the multi-channel input by:
analyzing voice commands through the speech processing module;
processing text-based commands through the keyword recognition module;
integrating GPS data with search parameters;
maintaining context across input channels by:
synchronizing user intent across voice and text inputs;
preserving search context across input methods;
combining location context with user queries;
adapting input processing based on:
user's preferred input methods;
historical success rates of different input channels;
current interaction context.
